(19) United States
(12) Patent Application Publication
(10) Pub. No.: US 2012/0176251 A1
(43) Pub. Date: Jul. 12, 2012

(54) DRILLING ACTIVITY LOGGING DEVICE, SYSTEM AND METHOD

(75) Inventors: Michael Alan Klass, Winthrop (AU); Brett James Wilkinson, Wembly Downs (AU); Gordon Henderson Stewart, Claremont (AU); Khaled Mufid Yousef Hejleh, Peppermint Grove (AU); Johan Anwar, Kalamunda (AU)

(73) Assignee: Globaltech Corporation Pty Ltd., Canning Vale, WA (AU)

(21) Appl. No.: 13/322,547

(22) PCT Filed: Jul. 27, 2011
(86) PCT No.: PCT/AU2011/000945

§ 371 Date: Mar. 25, 2012

(30) Foreign Application Priority Data
Jul. 27, 2010 (AU) 2010903344

(51) Int. Cl. G01V 3/12; G01V 3/00

(52) U.S. Cl. 340/854.6; 340/853.1

(57) ABSTRACT

A drilling log data logger 10, and system incorporating the same, has means 14-40 to receive drilling event related data, electronic storage means to store said input data, and output means 12,42 to output said data on demand. A related drilling log data recordal method for at least one drilling operation includes entering 100 initial drilling data into a data logger 10, said initial drilling data relating to at least one said drilling operation, creating current progress drilling data 108 in the data logger based on said initial drilling data, entering subsequent drilling data 110 into the data logger relating to one or more of a drilling task, drilling progress, drilling equipment or drilling operators of said drilling operation, comparing the subsequent drilling data 110 with the current progress drilling data 108; and updating the current progress drilling data 108 using the subsequent drilling data 110.

### TECHNICAL FIELD

The present invention relates to drilling activity logging device, system and method.

### BACKGROUND

In the mining, oil & gas and construction industries, as well as other industries that use drilling, daily drilling activities are recorded. To do this a “progressive log of drilling” is recorded. This is commonly termed a “Plod Sheet” or “Plod”, and refers to a “Daily Activity Sheet” or written log of drilling tasks at a particular site or machine for each operator shift. A drilling rig Plod includes details identifying the rig and location, operator names, operator hours, type of drilling activity, distance drilled, drilling consumables used and safety issues.

Current practice is to manually record the information on hard copy paper forms, with allocated rows and columns to simplify data recording by a drill rig operator. These forms are later compiled manually into a more structured form, sometimes in consultation with a geologist on site. The compiled hard copy forms are then collected from different drill rig sites and forwarded to ‘data entry’ personnel at the drilling company's office (sometimes outsourced to specialised data entry services). Drilling data is then manually methoded and entered by the data entry personnel into computer software programs that produce reports for the drilling company management and clients. These reports may be available immediately after data entry and computer methoding, or it may be delayed according to the frequency of PLOD compilation, manual data entry and methoding. This may even be after a week of activity on a drill rig. It will be appreciated that manual data entry is not only time consuming and labour intensive in transcribing the data already written by the operator(s), it is also prone to human error by the data entry personnel.

Reports that may be produced by currently available software programs after manual data entry from PLOD sheets include a spreadsheet detailing daily drilling, work time and consumables, a summary sheet/invoice with the drill holes listed, a summary of man hours for the period if required, and a summary of accidents, incidents and safety issues if required.

The PLOD sheet and reporting method is an essential part of any drilling company's activity, as it:

a) formalises all expenses and other additional costs to the paying client,

b) records drill rig crew man hours for wages calculation,

c) monitors efficiency and hence costs during drill rig operations,

d) highlights hazardous or safety issues which may be dealt with on future drilling activities.

However, given the importance placed on correct reporting of drilling activities and producing the necessary drilling history, problems and inefficiencies inherent in present methods of PLOD, data compilation and analysis include:

Manual writing of information to PLOD activity sheet by an operator may result in missed information or hand writing errors

Possibility of misplacing or damaging PLOD hard copy paper sheets due to environmental conditions at the mine site, such as water and muddy conditions, bad weather etc.

Possible human error when transferring Hole data from survey instrument readouts to PLOD sheets.

Possible human error when compiling multiple PLOD sheets and during manual data entry to computer system.

Furthermore, hand written hard copy PLOD sheets do not allow for interactive or dynamic recording and feedback relating to input data. For example, drilling data entered onto the present hard copy PLOD sheets is ‘dumb’ data—that is, there is no feedback in relation to budgets, timing, man hours, use of consumables etc.

It has been realised that improvements to the present method of capturing and recording PLOD data is required. With this in mind, it has been found desirable of the present invention to provide improved PLOD data capture and recording techniques that alleviate or remove the aforementioned problems.

### SUMMARY OF THE INVENTION

With the aforementioned in view, an aspect of the present invention provides an drilling data electronic log device including input means to receive data, electronic storage means to store said data, and output means to output said data on demand.

A further aspect of the present invention provides a drilling operations event records system incorporating a device according to any one of the preceding claims in combination with one or more remote metering devices provided on a drill rig to transmit drill rig operating conditions to the device.

The device may utilise hardware, firmware and software to electronically monitor (dynamic monitoring and feedback to operators) activity at a mining drill rig site through data input by an operator, such as; personnel hours, types of activity, metres drilled, consumables, maintenance scheduling, breakdowns, fuel usage, safety issues and costing.

Progressive logging, monitoring and feedback of drilling activities and events, shall be achieved using a newly developed electronic hand-held unit which records and provides dynamic (instant on-site) feedback to mine site personnel, providing analysis for efficiency and productivity of the drilling method, and eventually producing reports and generated costs for mining and exploration companies.

The device may preferably be a purpose built, user friendly hand held unit for recording data relating to drill rig and operator activity. The device may be constructed having a protective outer housing or casing so as to withstand rugged use in the field, such as when operating under harsh mining industry conditions and environments.

Data recorded into the device may be directly transferred to a USB thumb drive via a built-in host USB interface, or via hardwire or wireless connection, to a computer. The recorded drilling data may then be uploaded to the computer for instant, real time or delayed analysis, such as by using third party software, or using specially developed proprietary software. Manual data entry into computers is not necessary as information in the device's storage means or as transferred to one or more thumb drives may be formatted to readily work with a number of different software packages.

The device may be configured to provide instant ‘drill-rig specific’ feedback and analysis of drilling activity as it is occurring on site. This can enable operators to react instantly if drilling operations are not going according to plan or according to schedule and/or budget. This flexibility in operation and dynamic feedback is not possible using traditional handwritten PLOD sheets.

To further improve drilling event recording at the drill rig site, drill rig equipment may be fitted with one or more metering devices to directly transmit operating conditions to the device of the present invention, such as by infra red or other wireless communication. To facilitate this, the device may include an in-built transceiver, such as an infrared transceiver. As such, operators will not be required to ‘key in’ machine related conditions such as oil pressure, temperature, rig specific maintenance schedules etc. When used with a suite of survey instruments, drilling survey results may be directly input to the device via its in-built interface.

The device may also be integrated into partially or fully automated (and remote controlled) drill rig systems. The hardware and/or software functionality may be included as an embedded function of the automated rig to communicate with the device. Functionality may include voice information and instruction recording, as well as image recording as part of the system, from which can be derived ‘time and motion’ information, work progress, invoicing etc, with an automatic method of images and task recordings that back up the method.

The device may be programmable, such as to accept industry terms and nomenclature specific to drill rig activity logging. The inclusion of ‘predictive text’ functionality may further assist operators to quickly and accurately record drilling data and activity. Site related parameters (such as rig location, client details, site drilling specific requirements, scheduling etc) may be uploaded to the device via an in-built information communication interface, such as an infrared or USB interface, prior to or during drilling operations.

Device functionality, activity reports and site analysis may be directly related to an in-built ‘Real Time Clock’ in the device, which may provide a ‘time stamp’ for drilling events and activities on the drill rig site.

The specific ways in which an operator progressively encounters events when utilising one or more embodiments of the device, with data entry methods that closely emulate a traditional PLOD sheet, provides familiarity of use by the operator and hence, limited or no need for special user training. This is expected to enhance user acceptance of the device who are already familiar with the use of existing paper PLOD sheets.

The device according to one or more embodiments of the present invention eliminates the need for manual handwritten logs at the drill rig site and manual data entry for computer analysis programmes. There is minimal or no time delay in generating or receiving reports at the drill rig site or area site office.

A number of user recording functions may be automated, which all but eliminates human recording errors. Each device of the present invention may be upload configurable (such as through a USB or infrared port) to hold site, crew and job specific parameters, to further reduce the need to record basic information. In such a way, drilling and job data is always ‘ready’ and in a ‘manageable format’ for further analysis. There is no need for handwritten, printed or scanned sheets of paper for data analysis. All site activity data and reports may be digitally stored in the data storage means of the device, and are easily accessible via the in-built USB and Infrared ports. The stored data may then be made available ‘electronically’ and instantly transferable to any location around the world via LAN, via the internet, through land lines links, mobile networks or satellite modem communication media.

A further aspect of the present invention provides a drilling log data recordal method for at least one drilling operation, including the steps of:

a) entering initial drilling data into a data logger, said initial drilling data relating to at least one said drilling operation;

b) creating current progress drilling data in the data logger based on said initial drilling data;

c) entering subsequent drilling data into the data logger relating to one or more of a drilling task, drilling progress, drilling equipment or drilling operators of said drilling operation;

d) comparing the subsequent drilling data with the current progress drilling data; and

e) updating the current progress drilling data using the subsequent drilling data.

The initial drilling data may include one or more of the following:
i. a drillstring start direction data, such as a vertical or inclined drilling angle
ii. drillstring dip angle
iii. required drill hole diameter
iv. distance to target (e.g. in metres and/or number of drill rods)
v. global positioning data (e.g. geographic position of the drill site)
vi. operators or other people at that drilling operation
vii. information relating to the equipment being used
viii. time and date information

It will be appreciated that the initial drilling data is not limited to the aforementioned examples of drilling data and may include other drilling data not mentioned above.

In comparing the subsequent data with the current progress drilling data, a ‘sanity check’ or cross check can be carried out to ensure that the data entered is correct and makes sense. If incorrect data is entered, such as an incorrect length or number of drill rods or an incorrect size of drill bit, a error message or warning may be given. An error message or warning may one or more of a warning light, a message in text on a display or a combination of both.

If an operator has added a half length drill rod (for example a 3 m rod instead of a full length 6 m rod), a prompt may be given at a subsequent opportunity to either add a further half length rod so that the drillstring has the equivalent of a full length rod, or to replace the half length rod in use with a full length rod. Such a prompt may be given when the comparison between the subsequent drilling data and the current progress drilling data is carried out or at a time thereafter.

One particular benefit of the aforementioned method is that operator errors are avoided. The traditional “white board” or hand written paper hard copy means for capturing data relating to initial drill site setup and drilling progress is an opportunity for operator errors. There is no automatic mechanism for ensuring that drilling data is correct. An operator can make errors on a written sheet or white board that can go undetected, such as a wrong count of the number of drill rods in a drillstring and therefore propagating an error in the distance actually drilled. Another error may be in the number and/or type of consumable items used, such as drill bits.

The method may receive data from a remote site or equipment. For example, drill orientation data and/or survey data may be captured and input, such as part of the initial drilling data and/or the subsequent drilling data.

The method may include validating some or all of the data input into the data logger. The methods may include one or more algorithms or software that carries out a check that the input data is sensible in relation to set parameters or limitations. For example, such a check may be that the drill bit size or type data entered by an operator is within defined parameters and not outside of minimum or maximum values. Entered drilling equipment data or drilling operations data may be cross checked against stored data relating to subsurface geology, or vice versa, to ensure that the intended drilling equipment and, operating criteria match the geology to be drilled. Thus, self validation can be invaluable to ensure correct operations, avoid time wasted in correcting errors, and to reduce equipment wastage through otherwise using incorrect equipment.

The method may include prompting an operator to enter subsequent drilling data or to enter certain required subsequent drilling data before the method will carry out the comparison and/or update the current progress drilling data. Thus, an operator may be ‘flagged’ that no data or incorrect data has been entered and the process will not continue further until data entry has been satisfactorily completed.

The data logger may be a hand held electronic device with data entry means, such as an alphanumeric or other keypad, touch sensitive screen or voice activated software to effect receipt of data to be input into the data logger.

A record may be recorded via the data logger, such as in a memory, against at least one consumable item of equipment that the cost of which is to chargeable to a third party. This ensures cost recovery of consumables is not overlooked.

Comments by shift personnel on drilling progress, activities, tasks, personnel, events, equipment changes or decisions during drilling activities may be entered into the data logger and those comments subsequently provided to shift personnel at a shift change, thereby improving efficiency of shift changeover and ensuring that important information relating to drilling activities is passed on to the next shift to avoid information being forgotten or overlooked.

### BRIEF DESCRIPTION OF THE DRAWINGS

FIG. 1 shows a hand held data logger according to an embodiment of the present invention

FIG. 2 shows a flow chart of data entry for logging drilling operations according to an embodiment of the present invention.

### DESCRIPTION OF PREFERRED EMBODIMENTS

Embodiments of the present invention will hereinafter be described with reference to the accompanying figures.

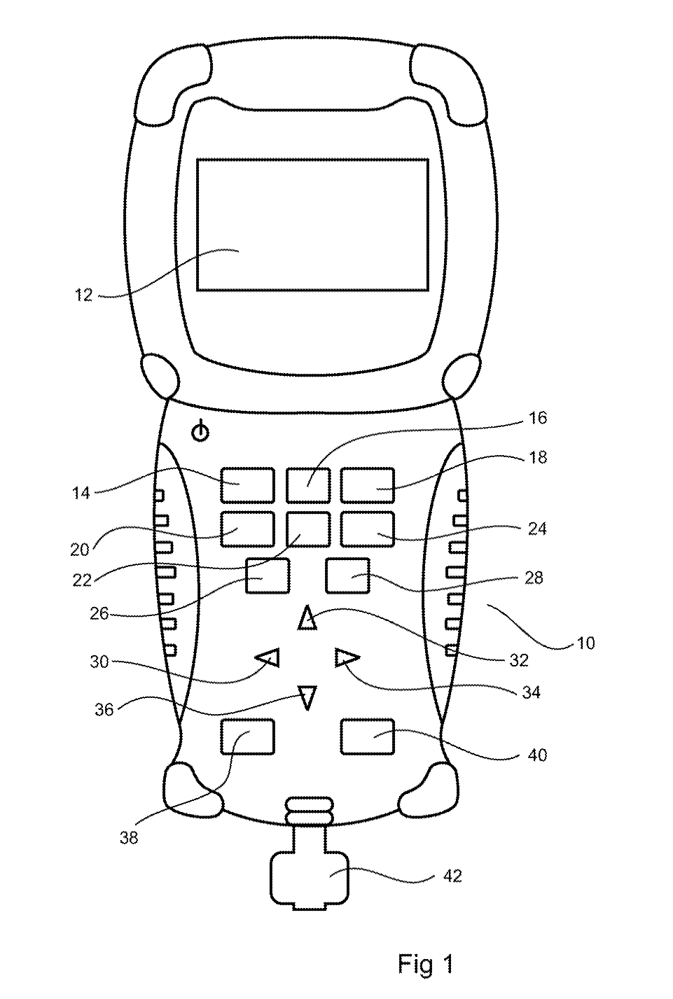

FIG. 1 shows a hand held electronic data logger 10. The data logger 10 has a display screen 12, data input buttons 14-28, navigation buttons 30-36, a “resume” button 38 and an “escape” button 40, and a data transfer port 42 (in this example a USB data port) for communication with other devices. The casing of the hand held device is shockproof and water resistant having rubberised grips and corner protection. The hand held device 10 can be powered by a rechargeable battery (not shown) or be mains powered.

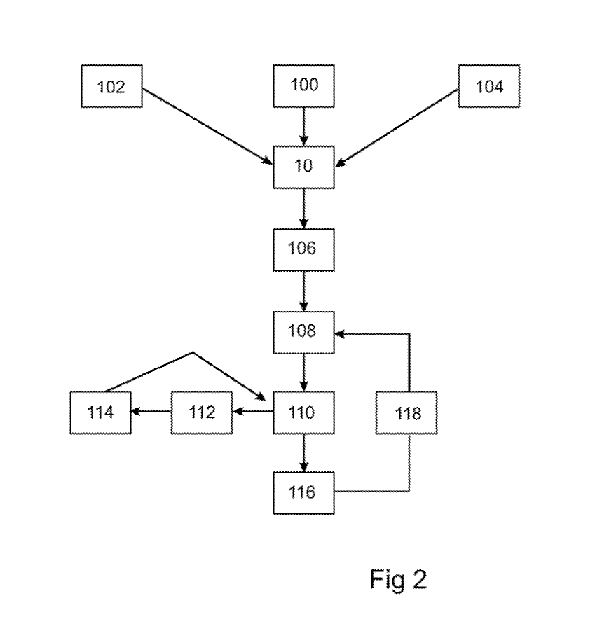

In use, data entry into the device is carried out by a drilling operator. Referring to FIG. 2, presuming first setting up equipment to commence drilling, initial drilling data is entered 100 into the device 10. Initial drilling can include information relating to the drill site (e.g. geographical location, geology, proximity to watercourses, building and installations etc, time and date, details regarding operators and other staff involved in the drilling operation, type of drill, distance to target, angle of inclination for drilling). Such initial data or additional data can be inputted 102, 104 from one or more remote sites, such as survey or orientation equipment, wirelessly. Further progress with entering drilling data will not be permitted unless at least minimum specified information is entered. Thus, initial data is captured and drilling operations cannot commence until a required prompt is given to the operator. This provides a validation step 106 to check that information entered is correct and meets at least minimum requirements. The amount and type of information required can be preset to ensure that the minimum information is sufficient for the drilling task in hand. Thus, more complex drilling tasks can require a present level of authorisation, values entered or specification of equipment or location before further and subsequent drilling data can be entered.

Once the required initial drilling data is recorded, current progress drilling data is created 108. This data can include distance drilled (which at the start of drilling may be zero), length and/or number of drill rods etc.

As drilling continues, subsequent drilling data can be entered 110. For example, the addition of further drill rods (number or length), progress in distance drilled, distance to target, any change in drilling equipment, elapsed time, change of operator personnel or consumables used.

A data validation or “sanity” check can be automatically carried out to ensure that the subsequent drilling data entered is valid and makes sense in relation to the initial drilling data and/or current progress drilling data. If the new subsequent drilling data is incorrect or does not make sense/is not rational 112 in relation to the previously entered data, an error indication can be given 114. This error indication can be a visual and/or audible indication. The current progress drilling data will not be completely updated or not at all updated until the correct or rational data is entered. For example, if the length or incremental number of drill rods is incorrect, an error prompt will be given and the current progress drilling data will not be updated.

If correct or rational subsequent drilling data is entered 110, and the “sanity” check is passed 116, the current progress drilling data 108 is updated 118. This avoids data entry errors and will not let an operator progress data entry or update current data unless correct or rational data is entered at the right point or as prompted.

The data logger 10 may be accessed remotely, such as by wireless and/or it may communicate data with one or more remote facilities or equipment. Thus, the data logger can include a transmitter and/or receiver. Drilling progress and status may be monitored remotely without having to speak to the operator on site.

Also, drilling progress and site operations can be monitored in near real time.

The data logger can include a clock or timer so that it optionally gives a prompt for fresh data after a set period or at the start or end of an operator shift.

If there is an active (open) drill hole (such as at the handover between one personnel shift finishing and another shift starting, initial drilling data need not be entered. However, data relating to the new shift may be required, such as personnel or operator details, time/date, any change of equipment, an update of consumables etc.

The accumulated data may be used for accounting and/or invoicing purposes. For example, number of personnel and time spent at the drill site, consumables used (drill bits, fuel etc), can all be accounted for and invoiced to the client.

The method and device of the present invention improves reliability of data capture and beneficially improves capture of drilling data for use in statistical analysis and accounting procedures. Human error is alleviated and a standard format of information capture is ensured. Hand written sheets or white board entries are avoided, along with the possibility of misreading or misinterpreting hand written data/information. Also, with the data in electronic format, the data can be transmitted/received and used within software packages for manipulation and ease of storage.

At the handover between one shift and another, the captured data cannot be misinterpreted or lost.

Furthermore, additional data may be imported from or exported to remote devices or systems. For example, survey or geological data may be imported into and used as part of the drilling data. One particular example is the geological data could update the distance or direction to target, and thereby automatically update target data within the device or method. Thus, accurate data and records are maintained.

The hand held data logger embodiments make the present invention practical, robust and secure in rugged working environments in the field. Further, with set prompts being given for data entry, errors are avoided.

Benefits to the driller of using a data logger according to one or more embodiments of the present invention include:
Continuous tracking of hole depth, rod string, rod count and barrel length
Instant access to hole data for review while drilling (including from previous shifts and until EOH) including:
   Individual run comments (e.g. rod count OK, bit change, cavity, water intercepted etc.)
   Surveys
   Comments entered relating to cross shift changeover
   Comments tagged against depth drilled
Personnel hours can be entered, saved, output and displayed
Start/stop times of drilling activities are recordable
Calculates current meters drilled and total meters per drill bit per reamer at any time and total meters drilled per shift and total core recovered as required
Provides correct depths for surveys, bits and reamer changes, and core orientation depths
Records condition and serial number of bits and reamers versus meters drilled
Prevents incorrect carry on of data from previous drill shifts
Provides seamless cross-shift transfer of drilling data for drilling data integrity.
   There are also benefits to the drilling supervisor and GEO:
Data is displayed accurately and clearly, and can be output to a computer for handling and display, thereby avoiding issues with unclear handwriting that causes a problem in handwritten logs
Manual calculations are avoided, and therefore errors are reduced. The data logger manages the necessary calculations for the operator
Accurate allocation of tasks and activities thus removing subjective interpretations and eliminating ambiguous reporting and subsequent delays and misinterpretations
Improved progress reporting, which can be done remotely by interrogating the data logger or sending data from the data logger to a remote site
   Benefits to the business enterprise requiring the drilling activity:
Uniform processes and training across all contractors and employees
Avoidance of manual calculations, with avoidance of mental calculation errors and handwriting errors
Instant account of actual progress against budget and expected progress
Statistics on consumables efficiently and accurately created
Efficiency monitoring and reporting on a variety of aspects of the drilling process, including daily monitoring to provide useful intelligence for improvements and to assist in future planning.
   Features of embodiments of the data logger and system include one or more of the following:
The data logger has a protective casing and is suitable for use in low temperatures, high temperatures, salt spray, dust, rain, mud, and can survive high physical G shocks from drops/International transit shocks or pressure from compression under vehicle tyres. Thus the data logger is tailor made to survive the harsh drilling environment.
The underlying operating platform is in machine language and therefore file sizes can be kept low making it easy to transfer copious amounts data cheaply, efficiently and seamlessly. i.e. micro data can be sent without graphic headers, font and form formats or formulas. Operators read data using proprietary software which contains the larger graphic bytes & algorithms.
Error checking routines ensure that saved flash data is robust, reliable and unlikely to become lost or corrupt
Push button data input means are tactile making data entry fast and reliable
Comments Menu with efficient filter making menus easy to compile, streamlined, consistent and therefore faster and more accurate than writing them
Auto-Add of new comments to menu makes the entry of comments easier with use
Screen and key backlighting ensures good visibility in all conditions
USB & wireless transceiver capability for seamless transfer of data to other third party systems and equipment.
Charging cradle equipped with fast infra-red transceiver and interface to allow for future implementation of other communication means (speed equivalent to about 1 second per shift including transmission integrity checks)
Built in GPS chip provides exact position of rig for safety reasons
Easy Back-up file to USB facilities ensures that data copies can be saved and easily stored, providing peace of mind (and compliance to risk management procedures)
Instant help and tech files stored within the handheld eliminate the need for paper manuals and improve the knowledge and skill of the operator instantly. This means faster training and implementation.
Non-volatile memory means no data loss even in the event of total power failure
Data deletion prevention if data was not backed up or transferred successfully to external storage
Short circuit protection on power terminals increases rig safety and reduced fire risk and overall product electrical robustness
Inbuilt chargeable Battery life well in excess of 12 hours (outlasts a shift)
Fully operational when charging (charging cradle wall mount & desk mount with quick detach/re-attach)
Tracking of hole depth and real time logging of activities provides an instant efficiency monitor. This helps drilling operation supervisors to manage information more efficiently and improve the quality of invoicing processes by reducing depth reporting errors.
Electronic run sheet logging facilities improves the overall field QA procedures by reducing errors and streamlining the ops process. Corporate Customers will value improved processes and this will improve the day to day customer relationships.
File utility features enable synchronisation between data loggers when necessary (important for underground drilling)
Machine language platform is flexible for future requirements to log maintenance schedules, fuel/oil checks, safety checks, Bit tests, Mud tests etc.
Special calculation algorithms ensure that consumable recording and activity are in sync (fault flagged if bit size doesn't match pipe size etc.)
Entry field definition for data integrity e.g. file type and character length match for database translation
Built in memory and input/output test ensures that device is functioning properly
Optional ‘integrated plug in’ hardware interface for expandability to meet future needs such reading of bar codes, camera, and any other functions that may be required in the future
Data can be sorted and output in any file format to be compatible with 3^{rd} party systems, such as Oracle, Acquire etc., which helps drilling contractors to meet customer reporting requirements.

One or more forms of the present invention provides a fully integrated electronic log of drilling, particularly relevant to the mining industry or other industries where drilling is required.

At least one embodiment of the present invention provides a handheld data logger tool that allows drillers to digitally record the progressive log of drilling including consumables, chargeables, all activities and tasks and comments on run by run basis. The tool performs all the necessary calculations and keeps the driller informed of the hole status on run by run basis and including the total rods, depth & rod string. The data logger tool also retains all relevant data regarding the hole from previous shifts, and keeps this data available for the drillers of following shifts and until the end-of-hole.

The data logger can provide a guided step by step set up the drilling shift and hole parameters and specification. Embodiments of the data logger are process & menu driven and when the operator enters a new item (like a name) the data logger remembers new entries and the next time these will be displayed on the menu. When the next shift is started for the same hole, the shift setup will be minimized to entering the operators' names. All other setup data that remains the same can be carried forward. Once the shift starts the driller can log activities as they happen from starting a run, adding rods, recording stickup, to consumables, bit & reamer changes and their condition, to actual duration of each activity or their start & finish time.

Because the data logger can incorporate an electronic run sheet, the depth for certain activities can be automatically logged, as well as the number of surveys & core orientations performed & logged.

At the end of each shift the driller may end the shift on the data logger. Additional data will be prompted at that time, such as operators hours. Once the shift is ended the shift data is transferred into a memory stick and then to a PC where dedicated software can be used to generate the log and run sheet reports.

Once the shift data is entered, the operator can edit the data to fix any error and then the Plod report can be printed, converted to a PDF file for transferring such as by emailing the file (preferably an editable version) to the GEO or admin office where it can be further viewed/edited or processed using software.

Shift data can also be loaded into a database where many additional management & operational reports can be generated from data logged from all shifts and all other drill rigs providing similar information or needing to share the data from the data logger relating to one or more other rigs or other data. Reports that can be output based on the logged drilling data include operators hours, bit & reamer reports, hole surveys, meters per rig, machine hours, consumables and more. The shift data can also be fed into the user's 3^{rd} party accounting or database.

The hand held data logger has many fail-proof features. It is robust and designed to be operated in the harsh drilling environment. Shift files cannot be deleted unless they have been transferred to an external memory and preferably the data logger may only hold four complete shifts intentionally to force the user to transfer the shift data to a PC for processing. This avoids accidental loss of shift data and causes the data to be processed in a timely manner.

The improved functionality of the data logger avoids ambiguity and eliminates errors due to miscalculations, eligible handwriting, omissions and other miscellaneous causes. It also can allocate user's codes to activities and consumables thus minimising subjective interpretations.

The data logger can be battery powered. To assist with battery power management: the data logger can revert to a standby mode after a preset time period, preferably after 35 seconds of inactivity. To resume operation from standby mode and return to the previous position, any pre-selected key may be pressed. After a predetermined period of inactivity, the data logger may power down and switch off. All saved data remains saved even when the data logger is switched off. To resume operations, the data logger is switched on via an on key/button

To maximise charging speed when connected to a charger, the data logger will revert to a standby mode after a predetermined amount of time, such as 7 minutes. To return from standby mode any key/button can be pressed. A low power indication may be given when the battery power data logger battery is depleted to a preselected level, such as 40% power reserve.

In setting up a drilling log activity in the data logger, such as at the start of a drilling shift, the following data may be entered: Date, Shift time (day or night or exact time), Drilling rig number, Location, Rig type, Site name, Operators (minimum 2 up to 5), Drill rig position (GPS), Client, Job number.

Hole setup is run next. This requires entering some or all of the following data: Type and purpose of drilling, Hole name, Start azimuth & start dip, Constant stick up, initial barrel length, Rod length, Start depth. Drill data may next be entered, including: Bit serial number, type and size or hammer serial number, type and size, Reamer serial number and type, 2^{nd} reamer (optional). Data entered at this point depends on the type of drilling to be undertaken.

Tasks that include chargeable items can be noted at data entry points, such as when entering drill bit, reamer and hammer data. A chargeable item can be unmarked in the data logger if the item is subsequently not to be charged or was incorrectly marked as chargeable. Charge markings are removed by going back to that data entry and reversing the charge entry through the input buttons.

An orientation can be logged for any given run at a respective depth.

End of shift data is entered into the data logger. This records the end of one shift prior to the next shift or the end of the drilling job. The end of shift data entry sequence may be irreversible, so a safety feature can be included that requires one or more buttons to be pressed for a required time or in a certain sequence, such as holding down one or more buttons for several seconds. Operator hours are then entered and the shift is ended.

At the end of hole, this sequence indicates that no more drilling is required. Once entered, the data logger identifies that hole as ended and a new hole will be started. Thus data entry reverts to the start of the setup sequence. As with the end of shift data entry sequence, a similar safety feature prevents end of hole sequence being commenced unless one or more buttons are pressed as required.

At end of shift or end of hole, data logged in the data logger (drilling and shift related data including consumables) can be transferred to a memory device or transmitted to a remote data receiver. The data can then be manipulated in a suitable software programme for display, accounting, reporting or planning etc. The data logger can backup data to a backup file for safety and security. This backup data can be a copy of the data logged during a drilling shift. This backup data can be restored to the main area of the data logger for ongoing use or can be output to a memory device or transmitted to a remote device.

Two data loggers may be used, such as on the same drilling rig. For example, one may be dedicated to the night shift and the other to day shift. Both collect data relating to the same drill hole. At the end of one shift, and after that shift is ended, a synchronising file can be created for the first data logger's recorded data during its shift. That synchronising file of data is restored to the second data logger for the other shift. Thus when that other shift starts, the second data logger is ready to continue on the same drill hole as the first data logger because it contains the same data. The first data logger can then be recharged, such as at the surface of a mine. Thus, the data logger is fully charged (such as when taken underground) for its shift and the use data logger can be returned for charging. This avoids loss of productivity and progress when drilling, especially if drilling activities are 24 hours a day, 7 days a week.

Embodiments of the present invention provide flexibility and reliability in drilling operation information/data capture, thereby providing economic and time saving benefits.

1. A drilling data electronic log device including input means to receive drilling event related data, electronic storage means to store said input data, and output means to output said data on demand.

2. A device according to claim 1, including hardware, firmware and/or software to electronically monitor activity at a mining drill rig site through data input by an operator.

3. A device according to claim 1, provided as a hand held unit.

4. A device according to claim 1, constructed having a protective outer housing or casing arranged to withstand rugged use in the field, such as when operating under harsh mining industry conditions and environments.

5. A device according to claim 1, being a self powered unit incorporating a rechargeable battery.

6. A device according to claim 1, including data transfer means enabling data input into or recorded in the device to be directly transferred to an external data storage device or computer.

7. A device according to claim 1, the device including a transmitter to wirelessly transmit drilling data to a remote location and/or a receiver to wirelessly receive drilling data from a remote location.

8. A device according to claim 1, including operator voice or image information and instruction recording or recognition, or activation of one or more functions of the device.

9. A drilling operations event records system incorporating a device according to claim 1 in combination with one or more remote metering devices provided on a drill rig to transmit drill rig operating conditions to the device.

10. A system according to claim 9, wherein the device is integrated with a partially or fully automated drill rig system.

11. A drilling log data recordal method for at least one drilling operation, including the steps of:
a) entering initial drilling data into a data logger, said initial drilling data relating to at least one said drilling operation;
b) creating current progress drilling data in the data logger based on said initial drilling data;
c) entering subsequent drilling data into the data logger relating to one or more of a drilling task, drilling progress, drilling equipment or drilling operators of said drilling operation;
d) comparing the subsequent drilling data with the current progress drilling data; and
e) updating the current progress drilling data using the subsequent drilling data.

12. A method according to claim 11, the initial drilling data including one or more of the following: drillstring start direction data, drillstring dip angle, required drill hole diameter, distance to target, global positioning data, operators or other people at that drilling operation, information relating to the drilling equipment being used, time and date information.

13. A method according to claim 11, including carrying out a data accuracy check on the subsequent drilling data by comparing the subsequent drilling data with the current progress drilling data.

14. A method according to claim 11, including providing a warning indication that incorrect initial and/or subsequent drilling data has been entered.

15. A method according to claim 14, wherein the warning indication includes an error message on a display or a warning light, or combinations thereof.

16. A method according to claim 11, including the data logger giving a prompt to an operator when the initial drilling data is entered or when the comparison between the subsequent drilling data and the current progress drilling data is carried out or at a time thereafter.

17. A method according to claim 16, whereby the prompt includes giving an indication to the operator that certain data requires entering into the data logger.

18. A method according to claim 11, further including receiving remote originating data transmitted from remote equipment and combining that remote originating data with the initial drilling data or subsequent drilling data.

19. A method according to claim 18, the remote originating data including survey data, geological data, GPS data and/or drill orientation data transmitted from remote equipment.

20. A method according to claim 11, further including validating for accuracy or correctness at least some of the initial or subsequent drilling data entered into the data logger.

21. A method according to claim 20, wherein validation includes checking that the inputted data is sensible in relation to set parameters or limitations.

22. A method according to claim 11, the method including prompting an operator to enter the subsequent drilling data or to enter certain required subsequent drilling data before the method will carry out the comparison and/or update the current progress drilling data.

23. A method according to claim 11, wherein the data logger is a hand held electronic device with data entry means, such as an alphanumeric or other keypad, touch sensitive screen or voice activated software to effect receipt of data to be entered into the data logger.

24. A method according to claim 11, including recording in the data logger a record against at least one consumable item of equipment that the cost of which is to chargeable to a third party.

25. A method according to claim 11, including entering into the data logger comments by shift personnel on drilling progress, activities, tasks, personnel, events, equipment changes or decisions during drilling activities, and providing those comments to subsequent shift personnel at a shift change.

26. Use of a hand held electronic device to carry out the method according to claim 11 to 25.
